(19) United States
(12) Patent Application Publication
(10) Pub. No.: US 2018/0081830 A1
(43) Pub. Date: Mar. 22, 2018

(54) HARDWARE SUPERVISION OF PAGE TABLES

(71) Applicant: Advanced Micro Devices, Inc., Sunnyvale, CA (US)

(72) Inventors: David Kaplan, Austin, TX (US); Sebastien Nussbaum, Boxborough, MA (US)

(21) Appl. No.: 15/270,708

(22) Filed: Sep. 20, 2016

(51) Int. Cl. G06F 12/14; G06F 12/1009

(52) U.S. Cl. CPC G06F 12/1483; G06F 2212/1052; G06F 12/1009

(57) ABSTRACT

A processing system includes one or more processing units, a memory including a protected region, and a hardware security module. The hardware security module is configured to selectively modify a page table stored in the protected region of the memory in response to write or modify requests from the at least one processing unit. In some variations, the hardware security module can modify the page table in response to verifying that a security criterion is met by the requested modification of the page table. The hardware security module can also access a code signature in response to a request to mark a page in the page table as eligible for execution and selectively mark the page as executable based on whether the code signature matches a signature of code stored in the page.

### BACKGROUND

### Description of the Related Art

Processing units, such as central processing units (CPUs), graphics processing units (GPUs), accelerated processing units (APUs), and the like, often implement software to execute one or more virtual machines that each emulate a separate computing platform. A hypervisor provides a virtual operating platform for guest operating systems running on the virtual machines. Programs that are executing on the virtual machines access data and instructions using virtual addresses that are mapped to physical addresses in memory using a page table. Each entry in the page table stores a mapping of a virtual address to a corresponding physical address, e.g., of a page of the physical memory. Entries in the page table also typically include information indicating other attributes of the referenced page such as an NX bit that indicates whether code stored in the page is available for execution, a dirty bit or a modified bit to indicate whether information in the page has been changed, a present bit to indicate whether the pages are in memory or stored on an external disk, and the like. The page table can be compromised by malicious attacks that allow the attacker to control aspects of a system or see data that the attacker is not authorized to access. Conventional page tables are accessible to operating systems, hypervisors, or other software, which increases the vulnerability of the page tables to attack. For example, an attacker could gain control of an operating system or a hypervisor that is executed by the processing unit, which could enable the attacker to write rogue code to a page in the memory and then modify the page table to reference the compromised page and allow the rogue code is to be executed.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system according to some embodiments.

FIG. 2 is a block diagram that illustrates software executable by the processing system according to some embodiments.

FIG. 3 is a diagram illustrating an example of a paged memory model according to some embodiments.

FIG. 4 is a flow diagram of a method of selectively modifying entries in a page table stored in a protected region of memory according to some embodiments.

FIG. 5 is a flow diagram of a method of selectively modifying attributes of entries in a page table stored in a protected region of memory according to some embodiments.

### DETAILED DESCRIPTION

The security of a page table is enhanced by storing page tables in a predetermined region of physical memory that can only be written or modified by a security module. Processing units (and software executing thereon) are permitted to access information in the predetermined region (e.g., to perform page table walks to identify virtual-to-physical address translations) but they are not granted permission to write or modify the predetermined region. For example, hardware in the processing units is configured to prevent the processing unit, as well as firmware or software executing thereon, from directly writing or modifying information stored in the predetermined region. Instead, the processing units are required to send requests to the security module to write or modify the predetermined region. The security module then verifies that one or more security criteria are met before modifying the page table. For example, the processing unit is required to send a request to the security module to create a mapping of a virtual address to a physical address of a page in physical memory. The security module rejects requests to create mappings that allow software executing on the processing unit to access the predetermined region because this would violate the security criteria that the processing unit (as well as firmware or software executing thereon) is not granted write or modify privileges in the predetermined region.

The security module can also implement enforcement of code signing to verify that code in pages outside the predetermined region is valid before modifying a page table attribute to allow the code to be executed. For example, a processing unit is required to request modifications to attributes of the entries in a page table stored in the predetermined region such as changes to a value of an NX bit that indicates whether code stored in the page referenced by the corresponding virtual address is available for execution. If the security module receives a request from a processing unit to mark a page as eligible for execution, the security module verifies the authenticity or integrity of the code stored in the page prior to changing the attribute of the page table to indicate that the code stored in the page is eligible for execution. Limiting the write and modify privileges for the predetermined region to the security module, and requiring the processing units to send requests to the security module to write or modify page tables in the predetermined region, also prevents software executing on the processing units from thwarting the security module by re-mapping the page table to a region of the memory that can be written or modified by software executing on the processing unit.

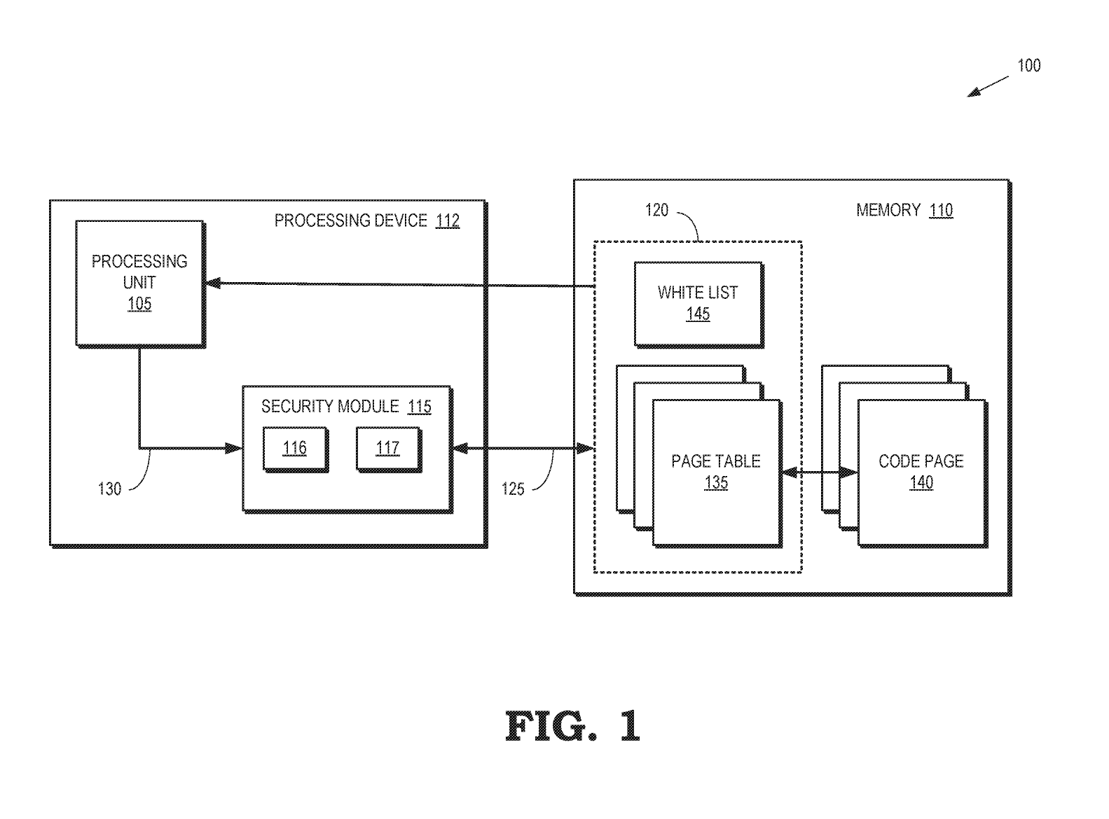

FIG. 1 is a block diagram of a processing system 100 according to some embodiments. The processing system 100 includes a processing unit 105 that is configured to execute instructions that are encoded as software that is stored in a memory 110. Some embodiments of the processing unit 105 are implemented as part of a processing device 112 that is fabricated on an integrated circuit chip, die, substrate, or package that is separate from the memory 110. The memory 110 is implemented as dynamic random access memory (DRAM) in some embodiments. The processing unit 105 represents, for example, a central processing unit (CPU), a graphics processing unit (GPU), an accelerated processing unit (APU), an application-specific integrated circuit (ASIC), a field programmable gate array (FPGA), a digital signal processor (DSP), a combination thereof, and the like. The processing unit 105 alternatively represents processor cores or compute units that are implemented in a CPU, GPU, APU, ASIC, FPGA, DSP, and the like. Although a single processing unit 105 is depicted in FIG. 1, some embodiments of the processing system 100 include more than one processing unit that is used to execute instructions concurrently or in parallel with instructions executed by the processing unit 105. Some embodiments of the processing unit 105 execute software instructions that are used to implement an operating system, a hypervisor, or one or more virtual machines which can each execute their own guest operating system. The processing unit 105 (or the virtual machines operating thereon) also execute software instructions that are used to implement other applications, such as third-party software.

The processing system 100 includes a security module 115 that provides secure access to a protected region 120 in the memory 110. The security module 115 is implemented using hardware that is distinct and separate from the hardware used to implement the processing unit 105 or other entities in the processing system 100. In some embodiments, the security module 115 is connected to the protected region 120 by a hardware interface 125, which can be implemented using traces, wires, or other hardware circuitry such as buffers, registers, multiplexers, demultiplexers, switches, routers, and the like. Some embodiments of the security module 115 include input buffers or registers 116 to receive requests to write or modify portions of the memory 110 and hardware circuitry 117 that is configured to selectively modify portions of the memory 110 in response to the requests, as discussed herein. The security module 115 is configured to have read-write-modify privileges within the protected region 120 of the memory 110. The security module 115 is operable to issue requests to read information from the protected region 120, write information to the protected region 120, or modify information that is stored in the protected region 120. Portions of the memory 110 outside the protected region 120 can be accessed directly by other entities in the processing system 100 such as the processing unit 105.

The protected region 120 cannot be written or modified by the processing unit 105, firmware associated with the processing unit 105, software executing on the processing unit 105, or other entities within the processing system 100 except for the security module 115. For example, hardware in the processing unit 105 is configured so that the processing unit 105 is given only read privileges within the protected region 120. Thus, the processing unit 105 can issue requests to read information in the protected region 120 and can receive information in response to the read requests. However, hardware in the processing unit 105 is configured so that the processing unit 105 does not have write or modify privileges within the protected region 120. Consequently, the processing unit 105 cannot directly write or modify locations within the protected region 120. In order to write or modify locations within the protected region 120, the processing unit 105 (or firmware or software executing thereon) is required to transmit write or modify requests to the security module 115, which then issues the write or modify requests to the protected region 120 in response to verifying, authenticating, or validating the request. For example, the processing unit 105 can be required to transmit all write or modify requests generated by the processing unit 105 (or software executing thereon) over a hardware interface 130, which can be implemented using traces, wires, or other circuitry such as buffers, registers, multiplexers, demultiplexers, switches, routers, and the like.

One or more page tables 135 are stored in the protected region 120. The page tables 135 are used to store mappings of virtual addresses used by software executing on the processing unit 105 to physical addresses in the memory 110. The physical addresses can be located in the protected region 120 or unprotected regions of the memory 110. The page tables 135 can include hypervisor mode tables, nested page tables, and the like. Storing the page tables 135 in the protected region 120 isolates the page tables 135 from the processing unit 105 (and firmware or software executing thereon). The processing unit 105 can perform read accesses such as page table walks to retrieve virtual-to-physical address translations from the page table 135. However, all requests to write or modify entries in the page tables 135 are transmitted to the security module 115. As used herein, the term “modify” is used to indicate any change to a value stored in a location in the memory 110. The term “modify” therefore refers to changes to the memory 110 caused by writing information to the memory 110, e.g., writing information indicating a mapping of a virtual address to a physical address to the page table 135, and changes to the memory caused by modifying information already stored in the memory 110, e.g., modifying an attribute of an existing entry in the page table 135. Modification of the page tables 135 can also include modification of a page table base address that identifies the base address of a hierarchical set of page tables, as discussed herein.

In response to receiving write or modify requests from the processing unit 105, the security module 115 is able to selectively modify the entries in the page tables 135 based on one or more security criteria. For example, the security module 115 can modify an entry in the page table 135 in response to verifying that a security criterion is met by the requested modification of the page table 135. Security criteria include only allowing requests to create or modify virtual-to-physical address mappings in the page table 135 that do not permit the processing unit 105 (or firmware or software executing thereon) to have write or modify privileges within the protected region 120. Requests that would permit the processing unit 105 (or firmware or software executing thereon) to have write or modify privileges within the protected region 120 are excluded. For example, the security module 115 can be configured to reject a request from the processing unit 105 to modify the page table 135 to create a mapping that allows software executing on the processing unit 105 to write or modify the protected region 120. Security criteria can also include only allowing requests to create or modify virtual-to-physical address mappings in the page table 135 that do not map the page table 135 to an unprotected portion of the memory 110. Requests that would map the page table 135 to an unprotected portion of the memory 110 are excluded. For example, the security module 115 can be configured to reject requests to create a new page table outside of the protected region 120 or to move the page table 135 (or portion thereof) from the protected region 120 to an unprotected region in the memory 110. Security criteria can further include prohibiting creation of write-able code pages so that all executable pages stored in the protected region 120 of the page table 135 are also marked as read-only pages. Security criteria can further include requiring that access to a subset of the protected region 120 is read-only. For example, if a physical address is in the subset of the protected region, virtual address mappings to the physical address are required to be read-only.

As discussed herein, the location of the page tables 135 is indicated by a page table base address. Some embodiments of the security module 135 include logic that is able to ensure that the page table base address is correct, e.g., the page table base address indicates a location within the protected region 120. The processing unit 105 can restrict the page table base address to locations within the protected region 120 or the processing unit 105 can request permission from the security module 115 to modify the page table base address of an existing page table 135 or request creation of a new page table at a page table base address. The security module 115 then selectively grants or denies the request to create or modify the page table base address.

Some embodiments of the memory 110 store information that represents software instructions that are executed by the processing unit 105. The information is stored in one or more code pages 140 that can be accessed by the processing unit 105 so that the processing unit 105 can retrieve the instructions for subsequent execution. The code pages 140 are stored in unprotected regions of the memory 110 so that the processing unit 105 (or other entities in the processing system 100) can read, write, or modify code that is stored in the code pages 140. For example, the processing unit 105 can write new code directly to the code page 140 or modify existing code stored in the code page 140 without intervention or mediation by the security module 115 because the code pages 140 are stored in the unprotected region of the memory 110. Software such as third-party applications or virtual machines executing on the processing unit 105 can also write code directly to the code pages 140 without intervention or mediation by the security module 115.

Prior to executing the code stored in the code pages 140, virtual-to-physical address mappings in the entries of the page table 135 need to be created or modified so that software executing on the processing unit 105 is able to access the information in the code pages 140 using virtual addresses. Attributes of the entries of the page table 135 can then be modified, e.g., to indicate whether the code stored at the physical address indicated by the entry is executable or not. However, as discussed herein, neither the processing unit 105 nor any firmware or software executing thereon is permitted to directly modify virtual-to-physical address mappings or attributes of entries of the page table 135. Instead, the processing unit 105 is required to transmit requests to modify the entries of the page table 135 to the security module 115, which can selectively modify the entries based on one or more security criteria. The processing unit 105 is therefore required to transmit a request to the security module 115 to mark entries associated with the new or modified code pages 140 as executable prior to executing the new or modified code.

The security module 115 can implement code signing to verify whether code stored in the code pages 140 is valid prior to marking entries associated with the code pages 140 as executable. Some embodiments of the security module 115 validate the code stored in the code pages 140 against known-good code pages. For example, a white list 145 can be stored in the protected region 120. The white list 145 includes signatures such as hashed values generated based on known-good code. The signatures can be provided by third-party vendors of the software or other trusted entities responsible for validating code. In response to receiving the request to mark one or more entries in the page table 135 as executable, the security module 115 generates a signature based on the new or modified code stored in the corresponding code pages 140. The security module 115 then accesses a signature of the known-good code from the white list 145 and compares it to the generated signature. The security module 115 validates the code if the signatures match and then modifies the attribute of the entry in the page table 135 to indicate that the code in the corresponding code page 140 is executable. However, if the signatures do not match, the security module 115 rejects the request to modify the attribute of the entry of the page table 135 so that the software stored in the code page 140 is not executable by the processing unit 105.

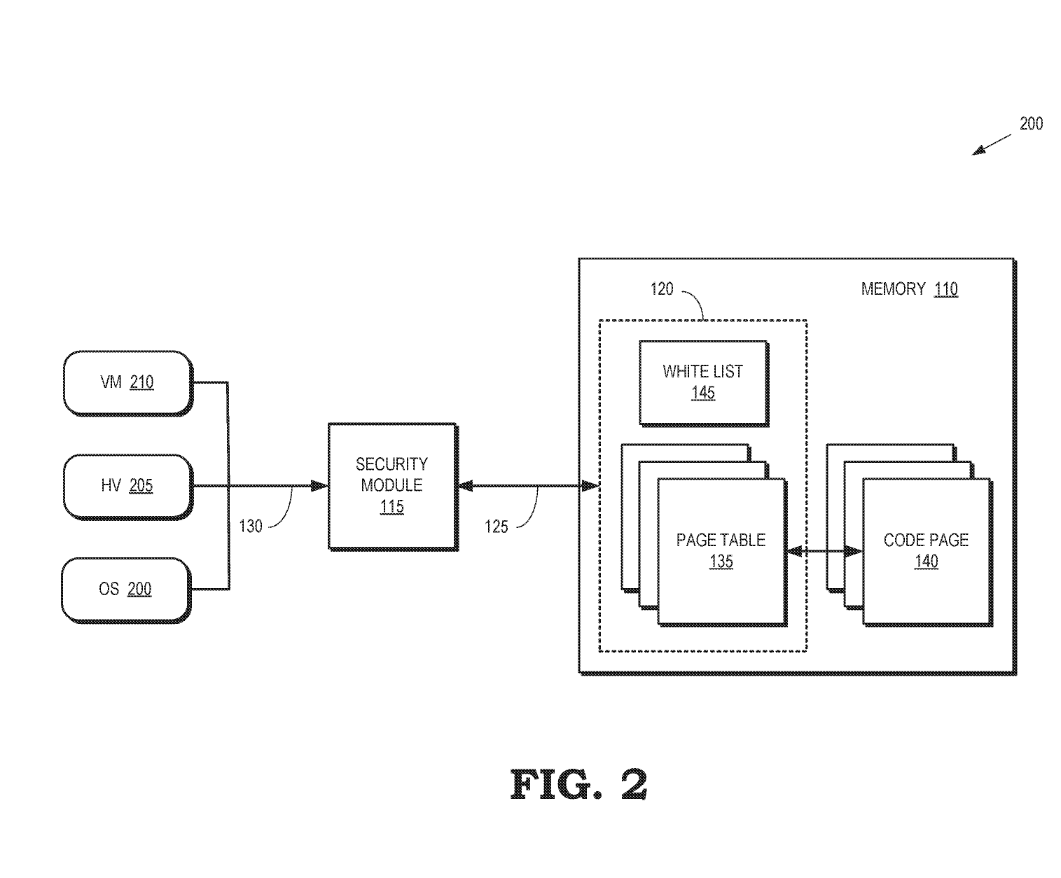

FIG. 2 is a block diagram that illustrates example software executed by the processing system 100 according to some embodiments. Some variations of the processing system 100 implement an operating system (OS) 200, a hypervisor (HV) 205, and one or more virtual machines (VM) 210, which can be implemented using software that is executed by one or more processing units such as the processing unit 105 shown in FIG. 1. The processing system 100 can also implement other software (not shown) such as guest operating systems implemented by the virtual machines 210, third-party applications, and the like. Software executing in the processing system 100 can be given read privileges to access data stored in the protected region 120 of the memory 110. However, software executing in the processing system 100 is not given write or modify privileges for data stored in the protected region 120. Consequently, the operating system 200, the hypervisor 205, and the virtual machines 210 are required to transmit requests to write data to the protected region 120 or to modify data stored in the protected region 120 to the security module 115 over the interface 130. The security module 115 can selectively modify information in the protected region 120 in response to determining whether the request satisfies one or more security criteria, as discussed herein.

Some embodiments of the security module 115 selectively implement code signing for subsets of the unprotected region of the memory 110. The subsets can be associated with different firmware, software, or applications. For example, a subset of the memory 110 that is allocated to the hypervisor 205 can be used to store code pages for the hypervisor 205. The security module 115 can be configured to apply some embodiments of the code signing technique described herein to the subset of the memory 110 allocated to the hypervisor 205. For another example, a different subset of the memory 110 can be allocated to one or more guest virtual machines 210 to store code pages for the guest virtual machines 210. The security module 115 can be configured to bypass enforcement of code signing for the code pages allocated to the guest virtual machines 210. In some embodiments, the different subsets of the memory 110 that are or are not subject to code signing can be negotiated during configuration of the corresponding software.

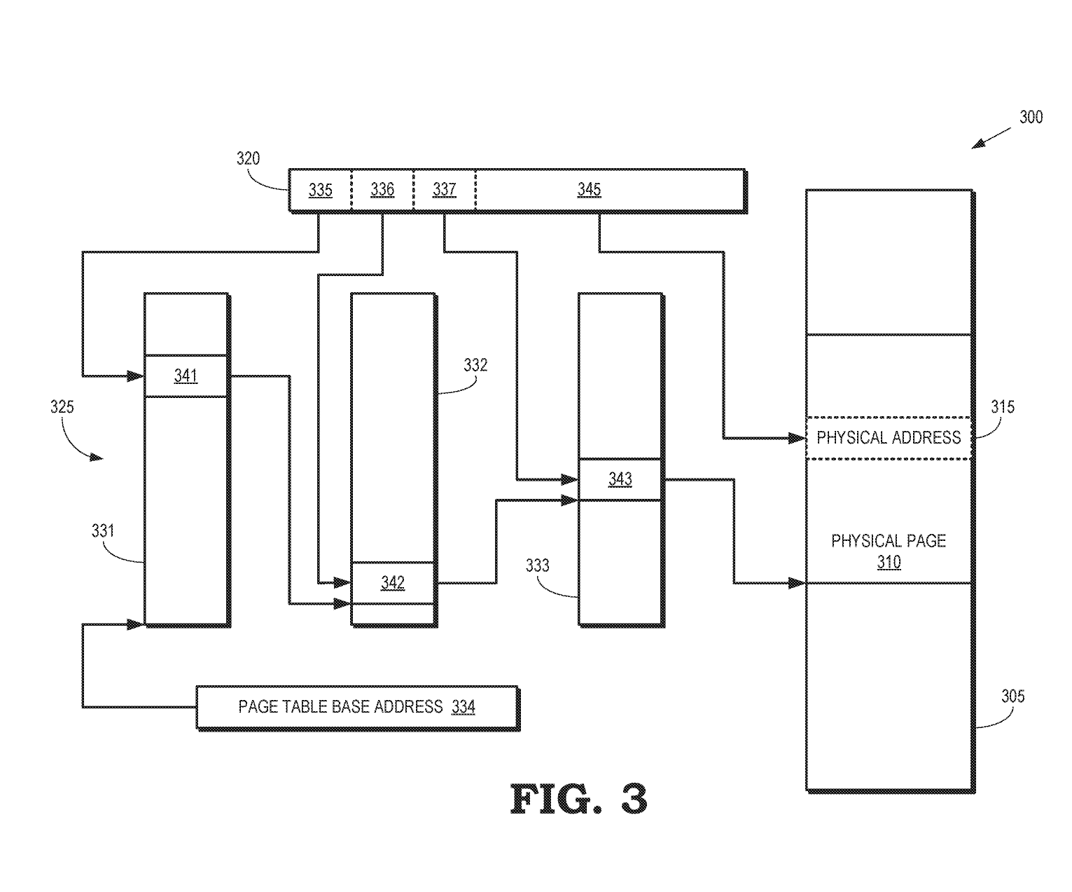

FIG. 3 is a diagram illustrating an example of a paged memory model 300 according to some embodiments. The paged memory model 300 is used to implement some embodiments of the page tables 135 that are stored in the protected region 120 of the memory 110 in the processing system 100 shown in FIGS. 1 and 2. The paged memory model 300 includes a physical memory 305 that is partitioned into physical pages such as the physical page 310, which is used to store instructions, data, values of attributes, and the like. Particular locations in the physical page 310 are identified by physical addresses such as the physical address 315. The locations in the physical page 310 can be accessed using a virtual address 320 that is mapped to the physical address 315. The paged memory model 300 therefore includes a translation table hierarchy 325 that is used to perform the virtual-to-physical address translation from the virtual address 320 to the physical address 315. In the illustrated embodiment, the translation table hierarchy 325 includes a hierarchy of three tables 331, 332, 333, which are collectively referred to herein as “the tables 331-333.” Although three tables 331-333 are shown in FIG. 3, some embodiments of the translation table hierarchy 325 include more or fewer tables. A page table base address 334 is used to indicate the base address of the translation table hierarchy 325.

Each of the tables 331-333 in the translation table hierarchy 325 is indexed by a corresponding portion of bits in the virtual address 320. For example, the bits 335 index the table 331, the bits 336 index the table 332, and the bits 337 index the table 333. Entries in the tables 331-333 referenced by the index bits 335-337 include pointers to a base address in the next-lower-level table in the translation table hierarchy 325. For example, the entry 341 in the table 331 includes a pointer to a base address of the entry 342 in the table 332. The entry 342 includes a pointer to a base address of the entry 343 and the table 333. The entry 343 includes a pointer to a base address of the physical page 310. The remaining bits 345 in the virtual address 320 indicate the physical address 315 in the physical page 310.

The paged memory model 300 also includes storage locations for storing information indicating attributes associated with the physical address 315. Values in a “dirty” field associated with the physical address 315 that are stored in the entries 341-343 to indicate whether a page at the memory location indicated by the physical address 315 is dirty (e.g., a value of 1 indicates that information in the page has been modified) or clean (e.g., a value of 0 indicates that none of the information in the page has been modified). Values in a “present” field associated with the physical address 315 that are stored in the entries 341-343 indicate whether the page is currently present in physical memory or on an external disk. Values in an “NX” field associated with the physical address 315 that are stored in the entries 341-343 indicate whether code stored in the page is eligible for execution by a processing unit such as the processing unit 105 shown in FIG. 1. For example, a value of 0 in the NX field indicates that code stored in the corresponding page is eligible for execution and a value of 1 in the NX field indicates that the code stored in the corresponding page is not eligible for execution. In some embodiments, the entries 341-343 include other fields to store values that indicate other attributes associated with the physical address 315. As discussed herein, the attributes of the physical address 315 can only be created, written, or modified by the designated security entity that has write and modify privileges within the protected region of the memory.

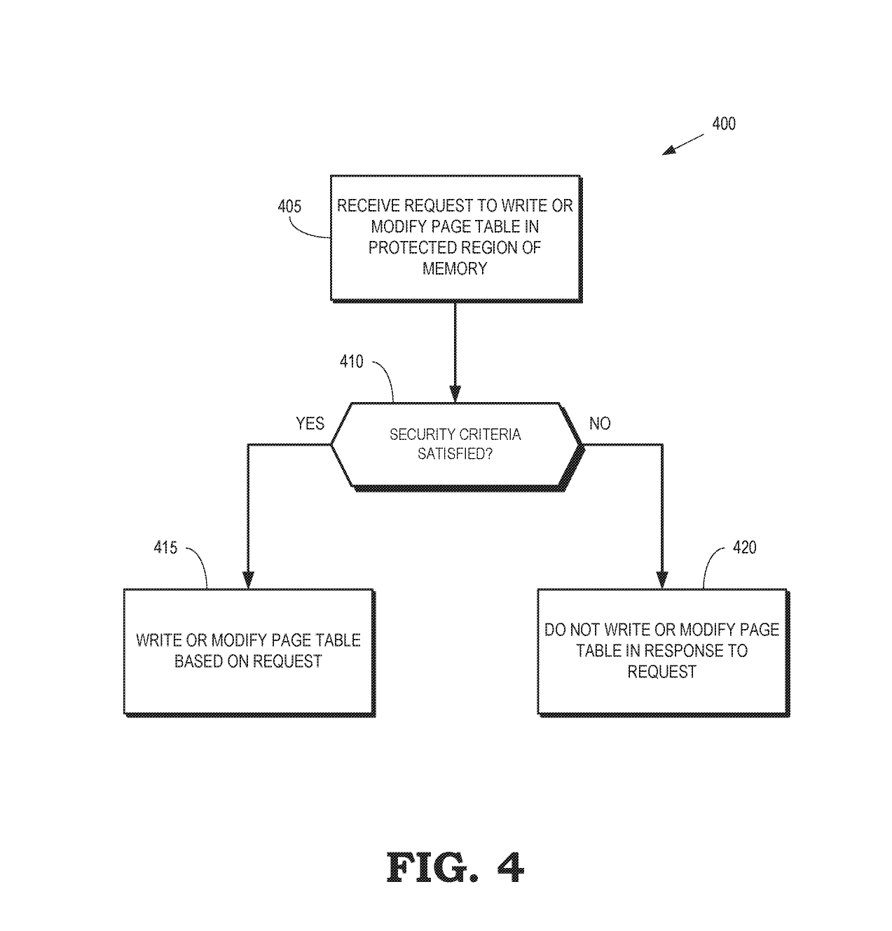

FIG. 4 is a flow diagram of a method 400 of selectively modifying entries in a page table stored in a protected region of memory according to some embodiments. The method 400 is implemented in a security module such as some embodiments of the security module 115 shown in FIG. 1.

At block 405, the security module receives a request to write or modify a page table stored in a protected region of memory. The request is received over a hardware interface to one or more processing units and the request can be generated by the processing unit or firmware or software executing thereon, such as an operating system, a hypervisor, a virtual machine, a third-party application, and the like. For example, the request is received from the processing unit 105 over the interface 130 shown in FIG. 1. For another example, the request can be received from the virtual machine 210 over the interface 130 shown in FIG. 2.

At decision block 410, the security module determines whether one or more designated security criteria are satisfied by the request. If the security criteria are satisfied, the method 400 flows to block 415 and the security module writes or modifies the page table based on the request. If the security criteria are not satisfied, the method 400 flows to block 420 and the security module bypasses writing or modifying the page table in response to the request. For example, the security module can reject the request so that the security module does not write or modify the page table in response to the request. In some embodiments, the security criteria applied at decision block 410 depends on the identity of the entity that issued the request to write or modify the page table. For example, different security criteria may be applied to different applications or different virtual machines that are executing on the processing system. The security module can therefore determine which application or virtual machine issued the request and then apply an application-specific or a virtual-machine-specific security criteria at decision block 410.

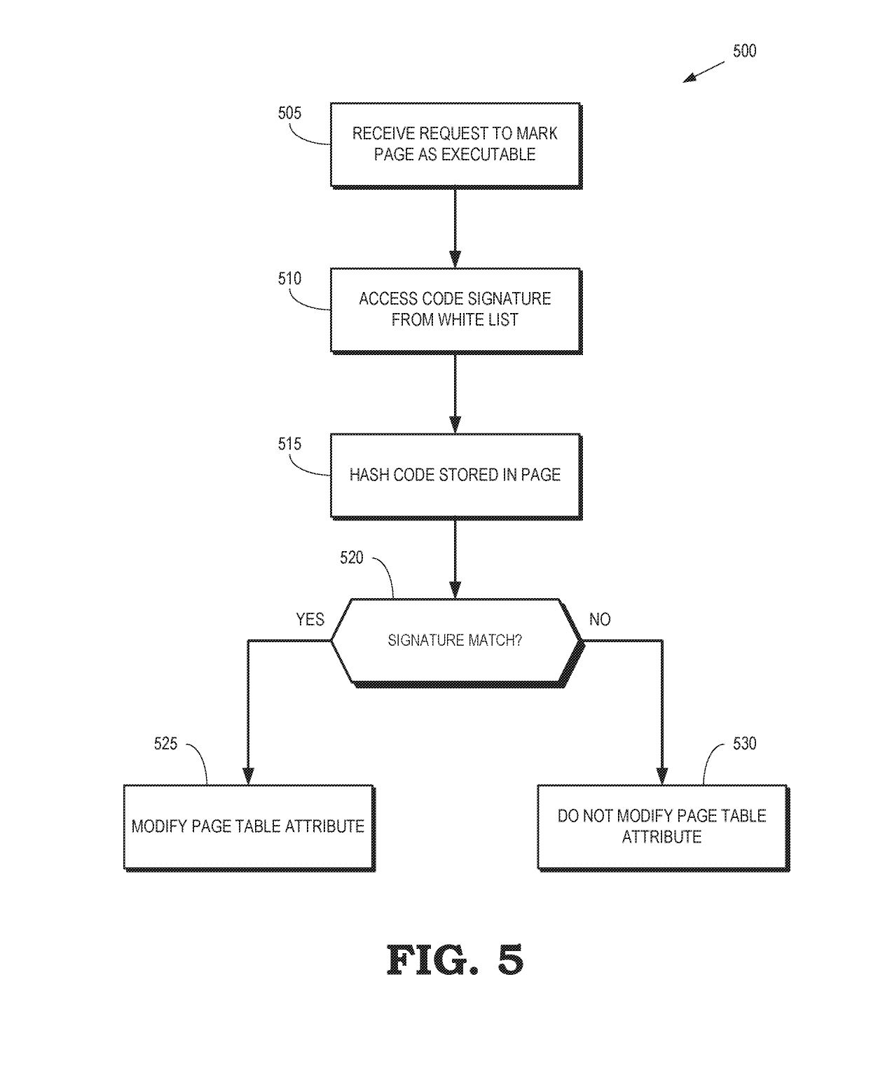

FIG. 5 is a flow diagram of a method 500 of selectively modifying attributes of entries in a page table stored in a protected region of memory according to some embodiments. The method 500 is implemented in a security module such as some embodiments of the security module 115 shown in FIG. 1. In the illustrated embodiment, the security module selectively modifies an attribute that indicates whether code stored at the physical page indicated in the page table includes code that is executable. The security module can therefore mark the page as executable by modifying the appropriate attribute, as discussed herein. Some embodiments of the security module selectively enforce code signing depending on the identity of the entity that is issuing the request to mark a page as executable. For example, code signing can be enforced for a first subset of virtual machines executing on the processing system and may not be enforced for a second subset of the virtual machines executing on the processing system.

At block 505, the security module receives a request to modify an attribute of an entry of a page table stored in a protected region of memory to indicate that a physical page associated with the entry includes executable code. The request is received over a hardware interface to one or more processing units and the request can be generated by the processing unit or firmware or software executing thereon, such as an operating system, a hypervisor, a virtual machine, a third-party application, and the like. For example, the request can be received from the processing unit 105 over the interface 130 shown in FIG. 1. For another example, the request can be received from the virtual machine 210 over the interface 130 shown in FIG. 2.

At block 510, the security module accesses a code signature from a white list such as the white list 145 shown in FIG. 1. The code signature is provided by a trusted third-party such as a vendor of the code. At block 515, the security module accesses the code stored in the page and generates another code signature using the access code. For example, the security module can hash the access code from the page according to the same hashing algorithm that would have been used to generate the code signature by the trusted third-party.

At decision block 520, the security module compares the two code signatures and determines whether they match. If the code signatures match, the method 500 flows to block 525 and the security module marks the page as executable by modifying the corresponding attribute in the page table in response to the request. If the two code signatures do not match, the method 500 flows to block 530 and the security module bypasses marking the page as executable in response to the request. For example, the security module can reject the request so that the security module does not write or modify the attribute of the entry in the page table to indicate that the corresponding page as executable in response to the request.

In some embodiments, certain aspects of the techniques described above are implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium can include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium can be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An apparatus, comprising:
at least one processing unit coupleable to a memory having a protected region; and
a hardware security module configured to selectively modify a page table stored in the protected region of the memory in response to a write request or a modify request from the at least one processing unit.

2. The apparatus of claim 1, wherein the at least one processing unit is configured to perform a table walk of the page table without intervention by the hardware security module.

3. The apparatus of claim 1, wherein the hardware security module is configured to write or modify the page table in response to verifying that a security criterion is met by the requested modification of the page table.

4. The apparatus of claim 3, wherein the security criterion excludes any mapping that allows software executing on the at least one processing unit to access the protected region.

5. The apparatus of claim 3, wherein the security criterion excludes any mapping to a writable code page.

6. The apparatus of claim 3, wherein the hardware security module is configured to access a code signature in response to a request to mark a page in the page table as eligible for execution and to selectively mark the page as executable based on whether the code signature matches a signature of code stored in the page.

7. The apparatus of claim 6, wherein the hardware security module is configured to access the code signature from the protected region in the memory.

8. The apparatus of claim 3, wherein the hardware security module is configured to determine an identity of an entity that requested the modification of the page table and apply a security criterion that is selected for the entity.

9. The apparatus of claim 1, wherein:
the at least one processing unit is configured to implement at least one of an operating system, a hypervisor, and a virtual machine; and
the hardware security module is configured to selectively modify the page table in response to write requests or modify requests generated by the at least one of the operating system, the hypervisor, or the virtual machine.

10. A method, comprising:
receiving, at a hardware security module of a processing system, a request from a processing unit of the processing system to write or modify a page table stored in a protected region of a memory of the processing system; and
selectively modifying the page table in response to the request.

11. The method of claim 10, wherein selectively modifying the page table comprises selectively modifying the page table in response to the hardware security module verifying that a security criterion is met by the requested modification of the page table.

12. The method of claim 11, wherein selectively modifying the page table comprises excluding any mapping that allows software executing on at least one processing unit of the processing system to access the protected region.

13. The method of claim 11, wherein selectively modifying the page table comprises excluding any mapping to a writable code page.

14. The method of claim 11, further comprising:
accessing a code signature in response to a request to mark a page in the page table as eligible for execution, and
wherein selectively modifying the page table comprises selectively marking the page as executable based on whether the code signature matches a signature of code stored in the page.

15. The method of claim 14, wherein accessing the code signature comprises accessing the code signature from the protected region in the memory.

16. The method of claim 11, wherein selectively modifying the page table comprises selectively modifying the page table based on an identity of an entity that generated the request.

17. The method of claim 10, wherein selectively modifying the page table comprises selectively modifying the page table in response to write or modify requests generated by at least one of an operating system, a hypervisor, and a virtual machine.

18. A hardware security module comprising:
an input buffer configured to receive a request from a processing unit to write or modify a page table stored in a protected region of a memory; and
hardware circuitry configured to selectively modify the page table in response to the request.

19. The hardware security module of claim 18, wherein the hardware circuitry is further configured to modify the page table in response to verifying that a security criterion is met by the requested modification of the page table.

20. The hardware security module of claim 18, wherein the hardware circuitry is further configured to:
reject a request to modify the page table to create a mapping that allows software executing on at least one processing unit of the processing system to access the protected region;
reject a request to modify the page table to create a mapping to a writable code page;
access a code signature in response to a request to mark a page in the page table as eligible for execution; and
selectively mark the page as executable based on whether the code signature matches a signature of code stored in the page.
